(19) United States
(12) Patent Application Publication
(10) Pub. No.: US 2026/0099530 A1
(43) Pub. Date: Apr. 9, 2026

(54) Data Processing Device, Data Processing Method, and Data Processing Program

(71) Applicant: Softbank Group Corp., Tokyo (JP)

(72) Inventors: Toshiyuki Nakatani, Tokyo (JP); Hidetoshi Morimoto, Tokyo (JP); Seunghyon Kang, Tokyo (JP)

(21) Appl. No.: 19/346,979

(22) Filed: Oct. 1, 2025

(30) Foreign Application Priority Data
Oct. 3, 2024 (JP) 2024-174590

(51) Int. Cl. G06F 16/335; G06F 16/338

(52) U.S. Cl. CPC G06F 16/337; G06F 16/338

(57) ABSTRACT

A data processing device includes: a processor, in which the processor is configured to collect input information from a specific user, the input information being related to a specific technology, specify, by using a generation model, a knowledge level of the specific user for the specific technology based on the collected input information from the specific user, generate, when information related to the specific technology is requested from the specific user, technical information for the specific user based on the requested information related to the specific technology and the knowledge level of the specific user for the specific technology by using the generation model, and output the technical information for the specific user to the specific user.

### CROSS REFERENCE TO RELATED APPLICATIONS

The present application claims priority from Japanese Patent Application No. 2024-174590, filed on Oct. 3, 2024, the entire disclosure of which is incorporated herein by reference.

### BACKGROUND

### Technical Field

The technology of the present disclosure relates to a data processing device, a data processing method, and a data processing program.

### Related Art

Japanese Patent Application Laid-Open (JP-A) No. 2022-180282 discloses a persona chatbot control method executed by at least one processor, the persona chatbot control method including: a step of receiving a user utterance; a step of adding the user utterance to a prompt including an instructional sentence associated with a description of a character of a chatbot; a step of encoding the prompt; and a step of inputting the encoded prompt into a language model to generate a chatbot utterance as a response to the user utterance.

### SUMMARY OF THE INVENTION

When, for example, a chatbot as described in JP-A No. 2022-180282 is requested to describe a specific advanced technology, the chatbot outputs a response content as an utterance based on information such as a paper in the corresponding field of the advanced technology. At this time, substantially the same information is output to all users if a content of the request is the same, but the degree of understanding of the output information greatly differs depending on whether the user is an expert in the field or a student or the like who does not have knowledge in the field.

A first aspect according to the technology of the present disclosure is a data processing device including a processor, in which the processor is configured to collect input information from a specific user, the input information being related to a specific technology, specify, by using a generation model, a knowledge level of the specific user for the specific technology based on the collected input information from the specific user, generate, when information related to the specific technology is requested from the specific user, technical information for the specific user based on the requested information related to the specific technology and the knowledge level of the specific user for the specific technology by using the generation model, and output the technical information for the specific user to the specific user.

A second aspect according to the technology of the disclosure is a data processing method including: collecting input information from a specific user, the input information being related to a specific technology; specifying, by using a generation model, a knowledge level of the specific user for the specific technology based on the collected input information from the specific user; generating, when information related to the specific technology is requested from the specific user, technical information for the specific user based on the requested information related to the specific technology and the knowledge level of the specific user for the specific technology by using the generation model; and outputting the technical information for the specific user to the specific user.

A third aspect according to the technology of the disclosure is a data processing program for causing a computer to execute processing including: collecting input information from a specific user, the input information being related to a specific technology; specifying, by using a generation model, a knowledge level of the specific user for the specific technology based on the collected input information from the specific user; generating, when information related to the specific technology is requested from the specific user, technical information for the specific user based on the requested information related to the specific technology and the knowledge level of the specific user for the specific technology by using the generation model; and outputting the technical information for the specific user to the specific user.

### BRIEF DESCRIPTION OF THE DRAWINGS

FIG. 1 is a conceptual diagram illustrating an example of a data processing system according to an embodiment;

FIG. 2 is a conceptual diagram illustrating an example of a hardware configuration of the data processing system;

FIG. 3 is a conceptual diagram illustrating an example of functions of main parts of a data processing device and a user terminal;

FIG. 4A is a conceptual diagram illustrating an outline of specification processing of specifying a knowledge level of a specific user for a specific technology;

FIG. 4B is a conceptual diagram illustrating an outline of specification processing of outputting technical information based on a request of a specific user;

FIG. 5 is a block diagram schematically illustrating a functional configuration of a specification processing unit of the data processing device;

FIG. 6 schematically illustrates an example of an operation flow of the specification processing performed by the data processing device; and

FIG. 7 schematically illustrates an example of an operation flow of the specification processing performed by the data processing device.

### DETAILED DESCRIPTION OF THE INVENTION

Hereinafter, exemplary embodiments of a data processing device, a data processing method, and a program according to the technology of the present disclosure will be described with reference to the accompanying drawings.

First, the wording used in the following description will be described.

In the following embodiments, a processor designated with a reference sign (hereinafter, simply referred to as “processor”) may be one arithmetic device or a combination of a plurality of arithmetic devices. In addition, the processor may be one type of arithmetic device or a combination of a plurality of types of arithmetic devices. Examples of the arithmetic device include a central processing unit (CPU), a graphics processing unit (GPU), a general-purpose computing on graphics processing units (GPGPU), and an accelerated processing unit (APU).

In the following embodiments, a random access memory (RAM) designated with a reference sign is a memory in which information is temporarily stored, and is used as a work memory by the processor.

In the following embodiments, a storage designated with a reference sign is one or more nonvolatile storage devices that store various programs, various parameters, and the like. Examples of the nonvolatile storage device include a flash memory (solid state drive (SSD)), a magnetic disk (such as a hard disk), and a magnetic tape.

In the following embodiments, a communication interface (I/F) designated with a reference sign is an interface including a communication processor, an antenna, and the like. The communication I/F manages communication between a plurality of computers. Examples of a communication standard applied to the communication I/F include wireless communication standards including 5^{th} generation mobile communication system (5G), Wi-Fi (registered trademark), Bluetooth (registered trademark), and the like.

In the following embodiments, “A and/or B” is synonymous with “at least one of A and B.” That is, “A and/or B” means only A, only B, or a combination of A and B. Furthermore, in the present specification, the same concept as “A and/or B” is applied also in a case where three or more matters are combined and expressed by “and/or”.

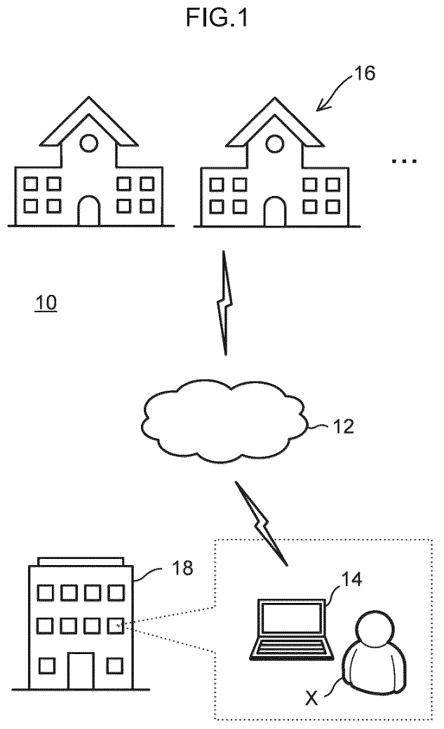

FIG. 1 illustrates an example schematically illustrating a data processing system according to an embodiment of the disclosure.

A data processing system 10 according to the present embodiment outputs technical information in a specific technical field based on a request for information regarding a specific technology from a specific user X. Then, the data processing system 10 outputs the technical information for the specific user in consideration of how much the specific user X has knowledge about the specific technical field.

Examples of a situation in which the user requires the technical information such as the latest papers can include a case where utilization of so-called industry-academia collaboration (or industry-academia-government collaboration) is being considered. The industry-academia collaboration is known as an initiative in which a company that wants to utilize an advanced technology and a research institution such as a university that wants to apply research results and technologies thereof to real society collaborate with each other, thereby leading to product development and creation of new businesses by the company. For realization of the industry-academia collaboration, it is necessary for a person in charge in the company to select, from among the research results of various research institutions, those that have potential for application to the business of the company, and to correctly understand the selected research results In the present embodiment, as an example of utilization of the data processing system 10, a case of supporting the person in charge of the company described above will be described.

As illustrated in FIG. 1, the data processing system 10 according to the present embodiment includes a data processing device 12 and a user terminal 14. In addition, the data processing system 10 may include a research institution 16. The user terminal 14 of the present embodiment is assumed to be carried by an employee working in a certain company 18. The employee described above is an example of the “specific user” according to the technology of the disclosure.

An example of the data processing device 12 included in the data processing system 10 is a server. Furthermore, examples of the user terminal 14 include a personal computer, a smartphone, and a tablet terminal. In the present embodiment, the data processing device 12 is an example of the “data processing device”according to the technology of the disclosure.

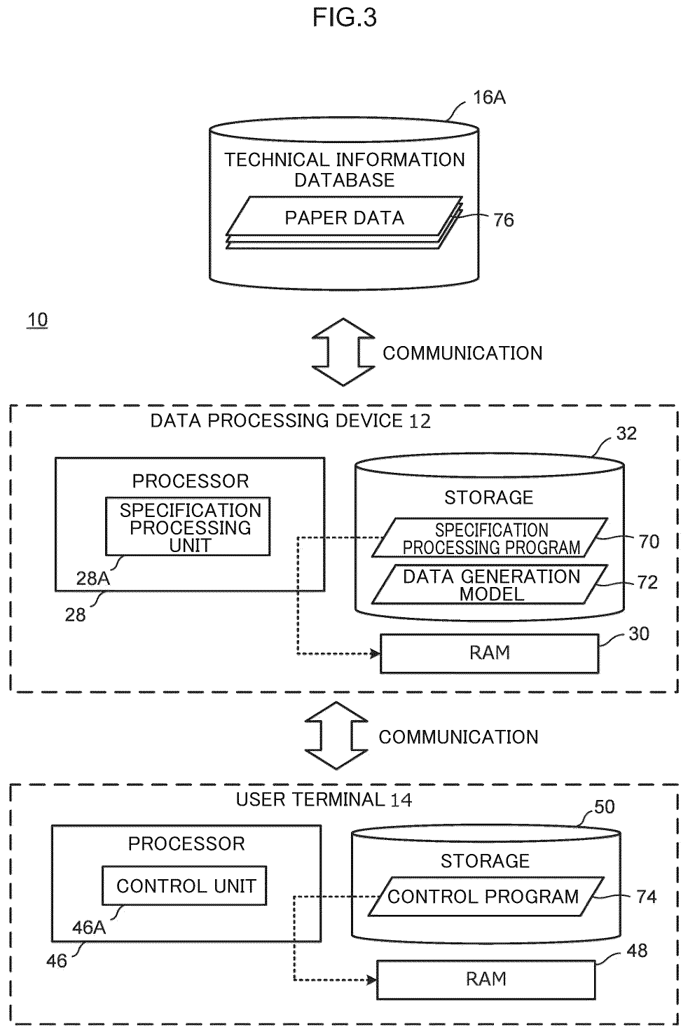

Furthermore, examples of the research institution 16 included in the data processing system 10 include one or more universities and laboratories. The research institution 16 may have paper data 76 (see FIG. 3) created by the research institution 16, as an example of the research result or a technology owned by the research institution 16.

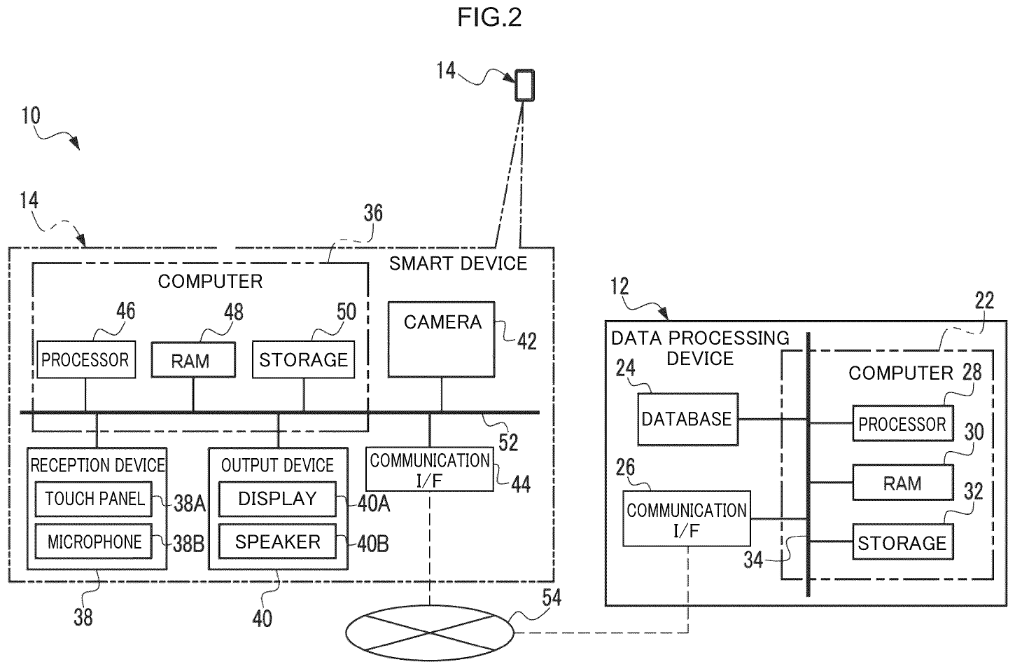

FIG. 2 illustrates an example of a hardware configuration of the data processing system 10 according to the embodiment.

As illustrated in FIG. 2, the data processing device 12 may include a computer 22, a database 24, and a communication I/F 26. The computer 22 is an example of the “computer” according to the technology of the disclosure. The computer 22 may include a processor 28, a RAM 30, and a storage 32. The processor 28 is an example of the “processor” according to the technology of the disclosure. The processor 28, the RAM 30, and the storage 32 are connected to a bus 34. The database 24 and the communication I/F 26 are also connected to the bus 34. The communication I/F 26 is connected to a network 54. Examples of the network 54 include a wide area network (WAN) and/or a local area network (LAN).

The user terminal 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. The reception device 38, the output device 40, and the camera 42 are also connected to the bus 52.

The reception device 38 includes a touch panel 38A, a microphone 38B, and the like, and receives a user input. The touch panel 38A detects a contact of an indicator (for example, a pen or a finger) to receive the user input by the contact of the indicator. The microphone 38B receives the user input by voice by detecting a speech of the user. A control unit 46A transmits data indicating the user inputs received by the touch panel 38A and the microphone 38B to the data processing device 12. In the data processing device 12, a specification processing unit 28A acquires data indicating the user input.

The output device 40 includes a display 40A, a speaker 40B, and the like, and presents data to a person 20 by outputting the data in an expression form (for example, voice and/or text) perceivable by the person 20. The display 40A displays visible information such as a text and an image according to an instruction from the processor 46. The speaker 40B outputs a speech according to an instruction from the processor 46. The camera 42 is a small digital camera on which an optical system including a lens, a diaphragm, and a shutter and an imaging element such as a complementary metal-oxide-semiconductor (CMOS) image sensor or a charge coupled device (CCD) image sensor are mounted.

The communication I/F 44 is connected to the network 54. The communication I/Fs 44 and 26 manage transmission and reception of various types of information between the processor 46 and the processor 28 via the network 54.

FIG. 3 illustrates an example of functions of main parts of the data processing device 12 and the user terminal 14.

In the data processing device 12, as illustrated in FIG. 3, specification processing is performed by the processor 28. The storage 32 stores a specification processing program 70. The specification processing program 70 is an example of the “program” according to the technology of the disclosure. The processor 28 reads the specification processing program 70 from the storage 32 and executes the read specification processing program 70 on the RAM 30. The specification processing is implemented by the processor 28 operating as the specification processing unit 28A according to the specification processing program 70 executed on the RAM 30.

The storage 32 stores a data generation model 72. The data generation model 72 is an example of a “generation model” according to the technology of the disclosure. The data generation model 72 is used in the specification processing unit 28A of the processor 28.

The data generation model 72 is a so-called generative artificial intelligence (AI).

Examples of the data generation model 72 include generative AIs such as ChatGPT (Internet search <URL:https://openai.com/blog/chatgpt>) and Gemini (Internet search <URL: https://gemini.google.com/?hl=ja>). The data generation model 72 is obtained by causing a neural network to perform deep learning. A prompt including an instruction is input to the data generation model 72, and pieces of inference data such as speech data indicating a speech, text data indicating a text, and image data indicating an image are input to the data generation model 72. The data generation model 72 infers the input inference data according to the instruction indicated by the prompt, and outputs an inference result in a data format such as speech data or text data. Here, the inference refers to, for example, analysis, classification, prediction, and/or summary.

Reception output processing is performed by the processor 46 in the user terminal 14. The storage 50 stores a control program 74. The control program 74 is used in combination with the specification processing program 70 by the data processing system 10. The processor 46 reads the control program 74 from the storage 50 and executes the read control program 74 on the RAM 48. The reception output processing is implemented by the processor 46 operating as the control unit 46A according to the control program 74 executed on the RAM 48.

In addition, the data processing device 12 may be able to communicate with a technical information database 16A. The technical information database 16A of the present embodiment is, for example, a database managed by the research institution 16, and may store the paper data 76 and the like created by the research institution 16. If the technical information such as the paper data 76 in the technical information database 16A is stored in advance in the storage 32 or the like in the data processing device 12, communication with the technical information database 16A at the time of performing the specification processing described below can be omitted.

Next, processing in the specification processing unit 28A when the data processing device 12 performs the specification processing of outputting the technical information for the specific user X based on a request from the specific user X will be described.

In the specification processing in the present embodiment, mainly two steps of processing are performed separately and sequentially or in parallel, so that the technical information for the specific user X is output in response to the request of the specific user X. Specifically, the specification processing in the present embodiment may include processing of specifying a knowledge level of the specific user X for the specific technology, and processing of outputting the technical information for the specific user X based on the request of the specific user X and the specified knowledge level. In the following description, the two steps of processing described above may be sequentially referred to as “first specification processing” and “second specification processing”.

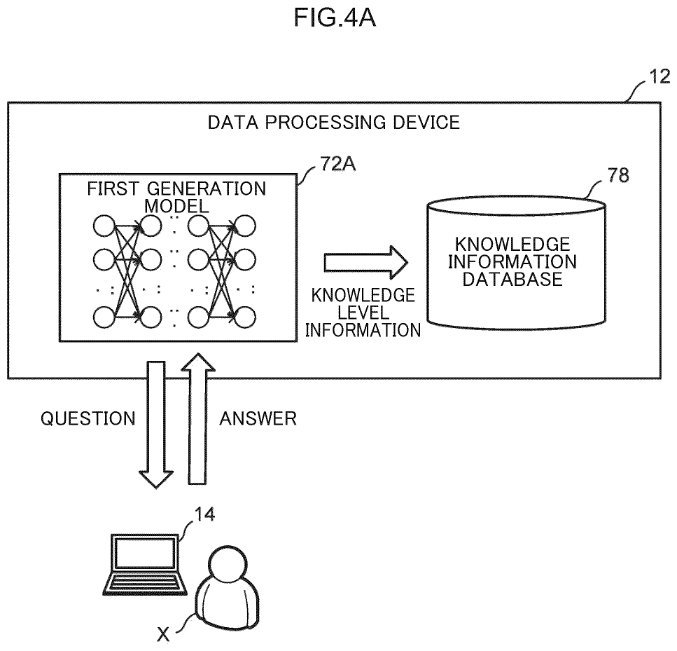

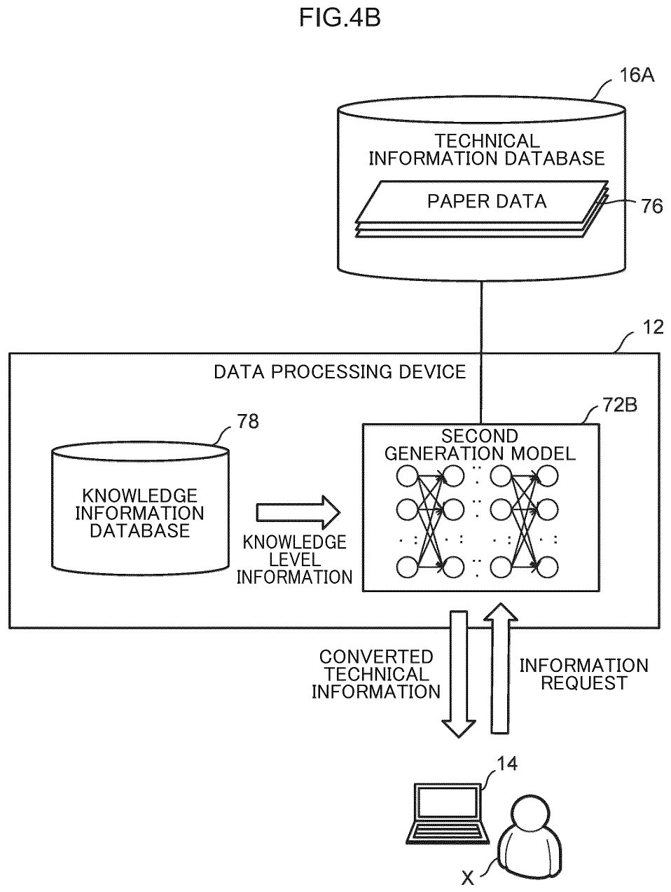

FIG. 4A is a conceptual diagram illustrating an outline of the specification processing of specifying the knowledge level of the specific user for the specific technology. As illustrated in FIG. 4A, the data processing device 12 first performs the first specification processing of specifying the knowledge level of the specific user X for the specific technology. The first specification processing can be referred to as processing of grasping a content understood by the specific user X regarding the specific technology and specifying the knowledge level of the specific user X for the specific technology by performing an interaction regarding the specific technology with the specific user X via the user terminal 14.

FIG. 4B is a conceptual diagram illustrating an outline of the specification processing of outputting the technical information based on the request of the specific user. As illustrated in FIG. 4B, when information related to the specific technical field is requested from the specific user X, the data processing device 12 performs the second specification processing. The second specification processing will be briefly described as processing of outputting the technical information for the specific user X based on the request from the specific user X and the specified knowledge level. Here, the technical information for the specific user X does not simply indicate a content of the selected technical information such as the paper data, but refers to information obtained by optimizing the selected technical information so as to be easily understood by the specific user X. Details of the first specification processing and the second specific processing described above are described below.

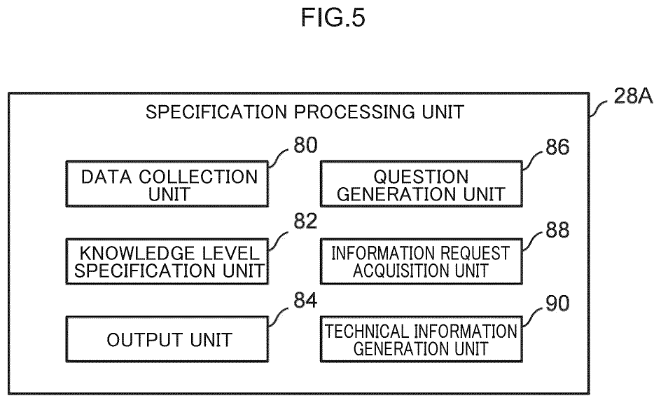

FIG. 5 is a block diagram schematically illustrating a functional configuration of the specification processing unit of the data processing device. As illustrated in FIG. 5, the specification processing unit 28A may include a data collection unit 80, a knowledge level specification unit 82, an output unit 84, a question generation unit 86, an information request acquisition unit 88, and a technical information generation unit 90.

The data collection unit 80 collects input information from the user, which is received by the user terminal 14. The input information referred to herein refers to the user input particularly related to the specific technology. The data collection unit 80 can acquire, as the input information, at least one of characters, a speech, and an image of the user received by the user terminal 14.

The knowledge level specification unit 82 performs the first specification processing illustrated in FIG. 4A. That is, the knowledge level specification unit 82 specifies the knowledge level of the specific user X for the specific technology based on the input information from the specific user X, which is collected by the data collection unit 80. For the specification, a first generation model 72A as an example of the data generation model 72 is used.

The output unit 84 transmits a result of the specification processing, a question generated by the data processing device 12, and the like to the user terminal 14. In the user terminal 14, the control unit 46A causes the output device 40 to output the received result of the specification processing, the received question, and the like.

The question generation unit 86 generates a question for collecting the input information by the data collection unit 80. The question may be a question related to the specific technology, the generated question is transmitted from the output unit 84 to the user terminal 14, and an answer to the question, which is transmitted from the user terminal 14, is collected as the input information in the data collection unit 80.

The information request acquisition unit 88 acquires a request for information related to the specific technology from the specific user X, the request being transmitted via the user terminal 14. The acquired request is used in the technical information generation unit 90.

The technical information generation unit 90 performs the second specification processing illustrated in FIG. 4B. That is, the technical information generation unit 90 generates the technical information for the specific user X based on the information related to the specific technology, which is acquired by the information request acquisition unit 88, and the knowledge level of the specific user X for the specific technology, which is specified by the knowledge level specification unit 82. A second generation model 72B as an example of the data generation model 72 is used to generate the technical information for the information. In the present embodiment, a case where the first generation model 72A and the second generation model 72B are provided according to a content of the specification processing is exemplified in order to facilitate understanding. However, the first specification processing and the second specification processing can be performed by one data generation model 72.

Next, actions of the data processing system 10 will be described.

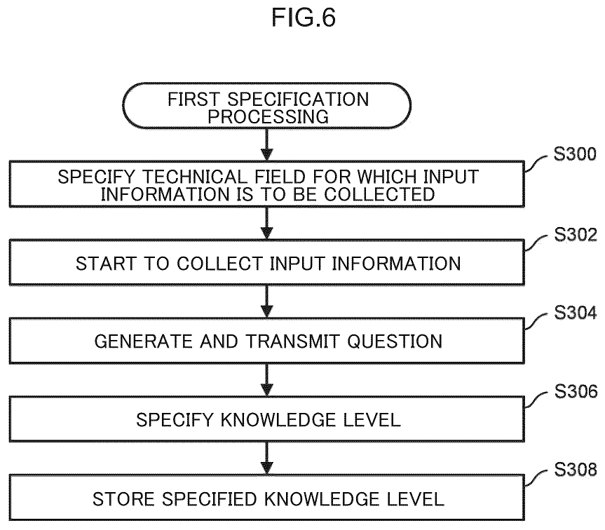

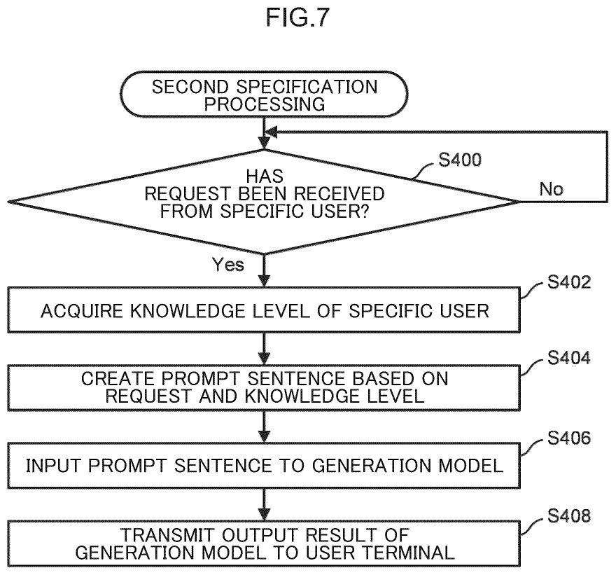

An example of a flow of the specification processing will be described with reference to FIGS. 6 and 7. The flow of the specification processing illustrated in FIGS. 6 and 7 is an example of the “data processing method” according to the technology of the disclosure. Furthermore, in order to further facilitate understanding of the specification processing, the following description exemplifies, if appropriate, as a specific example, a case where the specific user X is a person in charge of new business, the company 18 in which the specific user X works is a plastic manufacturing company, and the new business that the specific user X is in charge of is technology development of a horticultural plant planter.

As illustrated in FIG. 6, the specification processing according to the present embodiment includes, as the first specification processing, a process of collecting the input information from the specific user X, which is related to at least the specific technology (corresponding to step S302 described below), and a process of specifying the knowledge level of the specific user X for the specific technology based on the collected input information from the specific user X by using a generation model (corresponding to step S306 described below). Details are described below.

When the first specification processing is started, the data processing device 12 specifies a technical field for which the input information is to be collected in step S300. The technical field can be specified based on an input from the specific user or automatically by the data processing device 12 from an operation history or the like of the user terminal 14. Describing with a specific example, when the data processing device 12 specifies that the new business that the specific user X is in charge of is a plant planter, the data processing device 12 specifies a planter material field and a horticulture field as the technical fields for collecting the input information. In the present embodiment, a case where two technical fields of the input information to be collected are specified has been exemplified, but the number of technical fields may be only one or three or more.

Once the technical field for which the input information is to be collected is specified, the data processing device 12 starts to collect the input information in step S302. The input information can be collected by the data collection unit 80. A method of collecting the input information is not particularly limited, and can include a speech acquired by the user terminal 14, a text input to the user terminal 14 by the specific user, an image acquired by the user terminal 14, or the like.

In order to collect the input information more efficiently, the data processing device 12 may generate a question related to the technical field for collecting the input information and transmit the question to the user terminal 14 in step S304. The question generated here is not particularly limited as long as the question is related to the technical field for which the input information is collected, and the question may be a question such as “Have you ever grown a plant in a planter?” as a specific example. When an answer to the above-described question is transmitted from the user terminal 14, the data processing device 12 collects the answer as the input information in the data collection unit 80. A method of generating the question is not particularly limited. For example, the question generation unit 86 can generate the question by inputting a predetermined prompt sentence to the data generation model 72. Further, step S304 can be omitted.

Once the input information is collected, the data processing device 12 specifies the knowledge level of the specific user X in the specified technical field in step S306. The knowledge level is specified by the knowledge level specification unit 82 by using the first generation model 72A. At this time, it is preferable to create a prompt sentence instructing to output the knowledge level of the specific user X in the corresponding technical field based on the collected input information and input the generated prompt sentence to the first generation model 72A. Describing with a specific example, the data processing device 12 may create a prompt sentence “This user has grown plants in a planter three times. Please identify this user's knowledge level in the horticulture field” based on the input information, and may input the generated prompt sentence to the first generation model 72A.

Once the knowledge level of the specific user X in the specified technical field is specified, the data processing device 12 stores information regarding the specified knowledge level in a knowledge information database 78 in a form associated with the specific user X. The knowledge information database 78 can be implemented by, for example, a part of the storage 32.

By performing the first specification processing described above, the data processing device 12 can prepare in advance information specifying the knowledge levels of the specific user X for a plurality of technical fields. The information regarding the knowledge level of the specific user X in the specific technical field, which is accumulated or updated in the knowledge information database 78, is used in the second specification processing described below. An execution timing of the first specification processing described above is not particularly limited, but for example, the first specification processing can be performed at an arbitrary timing during a period in which the specific user X is performing a task in charge, or at a timing when information regarding the specific technology is requested from the specific user X.

In addition to the first specification processing described above, the specification processing according to the present embodiment includes, as the second specification processing, a process of generating, when the information related to the specific technology is requested at least from the specific user X, the technical information for the specific user X based on the information related to the requested specific technology and the knowledge level of the specific user X for the specific technology, by using the generation model as illustrated in FIG. 7 (corresponding to step S406 described below), and a process of outputting the technical information for the specific user X to the specific user X (corresponding to step S408 described below). Details are described below.

The second specification processing is performed with the acquisition of the request for the information related to the specific technology from the specific user X as a trigger in step S400. The request is transmitted from the user terminal 14 and is acquired by the information request acquisition unit 88 of the data processing device 12. Here, the information regarding the specific technology, which is included in the request described above, may include information regarding a business plan of a company. Describing with a specific example, the user terminal 14 transmits, to the data processing device 12, speech information or text information such as “Please explain the summary of a paper on the latest technology of plant planters” from the specific user X, whereby the second specification processing is performed.

The requested information regarding the specific technology may include additional information indicating a condition (in other words, a search condition) regarding paper information included in the technical information for the specific user. The additional information referred to herein can include, for example, information such as location information of a research institution that has created the paper and a creation date of the paper.

Once the request from the specific user X is acquired, the data processing device 12 acquires knowledge level information of the specific user X from the knowledge information database 78 in step S402. At this time, in a case where the knowledge level information for the technical field, which is related to the request of the specific user X, is not stored in the knowledge information database 78, the second specification processing may be temporarily interrupted, and the above-described first specification processing may be performed.

Once the acquisition of the knowledge level information for the technical field, which is related to the request of the specific user X, is completed, the data processing device 12 creates a prompt sentence to be input to the second generation model 72B in step S404. The generated prompt sentence may instruct to generate, based on the information included in the request and the acquired knowledge level information, the technical information for the specific user obtained by converting the technical information related to the requested information based on the knowledge level of the specific user X. Describing with a specific example, the data processing device 12 may create a prompt sentence “Please create a converted version of the latest paper related to plant planters, the content of the paper being transformed such that it can be understood by a user whose knowledge in the horticulture field is at a beginner level and whose knowledge in the planter material field is at an expert level”.

In addition, in a case where the requested information regarding the specific technology includes the above-described additional information, the additional information is preferably reflected in the prompt sentence created in step S404. Describing with a specific example, in a case where information indicating that the research institution that has created the paper is a university in Japan and that the paper has been created within the past year is included as the additional information, the data processing device 12 may create a prompt sentence “Please create a converted version of a paper related to plant planters, the paper having been created within the past year at a university in Japan, the content of the paper being transformed such that it can be understood by a user whose knowledge in the horticulture field is at a beginner level and whose knowledge in the planter material field is at an expert level”. In this way, by adding the additional information to the prompt sentence, it is possible to limit a source and a time of the technical information to be output, and for example, it is possible to reduce obstacles in the stage of using the technology in the industry-academia collaboration described above in advance.

After creating the prompt sentence, the data processing device 12 inputs the created prompt sentence to the second generation model 72B in step S406. Then, in step S408, an output result output by the second generation model 72B is transmitted to the user terminal 14 as the technical information for the specific user X.

As described above, with the data processing device 12, the data processing method, and the data processing program according to the present embodiment, the technical information output by the data processing device 12 has a format optimized for each user, and it is thus easy for the user to understand the technical information. In addition, if the data processing device 12 and the like described above are used in the field of industry-academia collaboration, it can be expected to prompt the use of the technology owned by the research institution by companies.

In the above-described embodiment, a case where the knowledge level of the specific user X in each technical field is implemented by information indicated in stages such as the “beginner level” and the “expert level” has been exemplified as the knowledge level information, but the knowledge level information is not limited to such information. For example, knowledge optimized for each user based on the input information obtained by an interaction including a question and an answer between the data processing device 12 and the user terminal 14 may be stored in a form like a dictionary and used in the second specification processing. The dictionary referred to herein refers to a glossary obtained by converting descriptions of terms used in each technical field according to the degree of understanding of each individual user.

Furthermore, in the above-described embodiment, a case where the specific user X is an employee working in a company, and the specific user X examines the latest technology related to the business of the company has been exemplified, but the technology of the disclosure is not limited to such a utilization method. Examples of other utilization methods include a case where a user working in a research institution searches for the latest business plan, products for sale, and the like of a company in order to search for a company that can put the technology that the user is studying into practical use. In this case, business plans and the like of various companies may be recorded in advance in the technical information database 16A or the like.

Although the functions of the data processing device 12 have been mainly described above as the system according to the disclosure, the system according to the disclosure is not necessarily implemented in a server. The system according to the disclosure may be implemented as a general information processing system. The disclosure may be implemented as, for example, a software program operating on a personal computer or an application operating on a smartphone or the like. The method according to the disclosure may be provided to a user in a software as a service (SaaS) format.

In the above embodiment, a mode example in which the specification processing is performed by one computer 22 has been described, but the technology of the disclosure is not limited thereto, and distributed processing for the specification processing by a plurality of computers including the computer 22 may be performed.

In the above embodiment, the description has been given by exemplifying a mode example in which the specification processing program 70 is stored in the storage 32, but the technology of the disclosure is not limited thereto. For example, the specification processing program 70 may be stored in a portable computer-readable non-transitory storage medium such as a universal serial bus (USB) memory. The specification processing program 70 stored in the non-transitory storage medium is installed in the computer 22 of the data processing device 12. The processor 28 performs the specification processing according to the specification processing program 70.

In addition, the specification processing program 70 may be stored in a storage device such as a server connected to the data processing device 12 via the network 54, and the specification processing program 70 may be downloaded and installed in the computer 22 in response to a request from the data processing device 12.

It is not necessary to store the entire specification processing program 70 in a storage device such as a server connected to the data processing device 12 via the network 54 or to store the entire specification processing program 70 in the storage 32, and a part of the specification processing program 70 may be stored in a storage device such as a server connected to the data processing device 12 via the network 54 or in the storage 32.

The following various processors can be used as hardware resources for performing the specification processing. Examples of the processor include a CPU which is a general-purpose processor functioning as a hardware resource that performs the specification processing by executing software, that is, a program. In addition, examples of the processor include a dedicated electric circuit which is a processor having a circuit configuration exclusively designed for performing the specification processing, such as a field-programmable gate array (FPGA), a programmable logic device (PLD), or an application specific integrated circuit (ASIC). A memory is built in or connected to any processor, and any processor performs the specification processing by using the memory.

The hardware resource that performs the specification processing may be implemented by one of these various processors, or may be implemented by a combination of two or more processors of the same type or different types (for example, a combination of a plurality of FPGAs or a combination of a CPU and an FPGA). The hardware resource that performs the specification processing may be one processor.

As an example of the configuration in which the hardware resource is implemented by one processor, first, there is a mode in which one processor is implemented by a combination of one or more CPUs and software, and the processor functions as the hardware resource that performs the specification processing. Second, as represented by a system-on-a-chip (SoC) or the like, there is a mode of using a processor that implements a function of the entire system including a plurality of hardware resources that perform the specification processing with one IC chip. In this manner, the specification processing is implemented by using one or more of the above-described various processors as the hardware resources.

Furthermore, more specifically, an electric circuit in which circuit elements such as semiconductor elements are combined can be used as a hardware structure of these various processors. In addition, the above-described specification processing is merely an example. Therefore, it is needless to say that unnecessary steps may be deleted, new steps may be added, or the processing order may be changed without departing from the gist.

The contents described and illustrated above are detailed descriptions of parts according to the technology of the disclosure, and are merely examples of the technology of the disclosure. For example, the above description regarding the configuration, function, action, and effect is a description regarding an example of the configuration, function, action, and effect of the part according to the technology of the disclosure. Therefore, it is needless to say that unnecessary parts may be deleted, new elements may be added, or replacement may be made with respect to the above described and illustrated contents without departing from the gist of the technology of the disclosure. Furthermore, in order to avoid complication and to facilitate understanding of the part according to the technology of the disclosure, in the description content and the illustrated content described above, description regarding technical common sense or the like that does not require any particular description in enabling implementation of the technology of the disclosure is omitted.

All documents, patent applications, and technical standards mentioned herein are incorporated herein by reference to the same extent as if each individual document, patent application, and technical standard were specifically and individually stated.

What is claimed is:

1. A data processing device comprising:
a processor, wherein the processor is configured to:
collect input information from a specific user, the input information being related to a specific technology;
specify, by using a generation model, a knowledge level of the specific user for the specific technology based on the collected input information from the specific user;
generate, when information related to the specific technology is requested from the specific user, technical information for the specific user based on the requested information related to the specific technology and the knowledge level of the specific user for the specific technology by using the generation model; and
output the technical information for the specific user to the specific user.

2. The data processing device according to claim 1, wherein the processor is further configured to:
generate a question related to the specific technology and output the question to the specific user; and
collect an answer of the specific user to the question as the input information from the specific user, the input information being related to the specific technology.

3. The data processing device according to claim 1, wherein
the processor is further configured to
generate the technical information for the specific user by using the generation model and a prompt sentence instructing to generate the technical information for the specific user based on the information requested by the specific user and the specified knowledge level of the specific user for the specific technology, the technical information for the specific user being obtained by converting technical information related to the requested information based on the knowledge level.

4. The data processing device according to claim 1, wherein
the information related to the specific technology, which is requested by the specific user, includes information regarding a business plan of a company, and the technical information includes paper information created by a research institution.

5. The data processing device according to claim 4, wherein
the information related to the specific technology further includes additional information indicating a condition of the paper information included in the technical information for the specific user.

6. A data processing method using a computer, the data processing method comprising:
collecting input information from a specific user, the input information being related to a specific technology;
specifying, by using a generation model, a knowledge level of the specific user for the specific technology based on the collected input information from the specific user;
generating, when information related to the specific technology is requested from the specific user, technical information for the specific user based on the requested information related to the specific technology and the knowledge level of the specific user for the specific technology by using the generation model; and
outputting the technical information for the specific user to the specific user.

7. A non-transitory recording medium on which a data processing program is recorded,
the data processing program causing a computer to execute processing including:
collecting input information from a specific user, the input information being related to a specific technology;
specifying, by using a generation model, a knowledge level of the specific user for the specific technology based on the collected input information from the specific user;
generating, when information related to the specific technology is requested from the specific user, technical information for the specific user based on the requested information related to the specific technology and the knowledge level of the specific user for the specific technology by using the generation model; and
outputting the technical information for the specific user to the specific user.
